(19) United States
(12) Patent Application Publication
(10) Pub. No.: US 2026/0189018 A1
(43) Pub. Date: Jul. 2, 2026

(54) SYSTEM AND METHOD FOR PROVIDING BLACKSTART OF GRID-FORMING INVERTER-BASED RESOURCES

(71) Applicant: General Electric Renovables Espana, S.L., Barcelona (ES)

(72) Inventors: Veena Padmarao, Bengaluru (IN); Kapil Jha, Bengaluru (IN); Rabisankar Roy, Bengaluru (IN); Subbarao Tatikonda, Bengaluru (IN); Arvind Kumar Tiwari, Niskayuna, NY (US)

(21) Appl. No.: 19/131,080

(22) PCT Filed: Nov. 21, 2022
(86) PCT No.: PCT/US2022/050533

§ 371 Date: May 19, 2025

(51) Int. Cl. H02J 3/388; H02J 3/38; H02J 3/44; H02J 101/28; H02M 1/36

(52) U.S. Cl. CPC H02J 3/388; H02J 3/381; H02J 3/44; H02M 1/36; H02J 2101/28

(57) ABSTRACT

A method of synchronized blackstart in a power generating farm connected to an electrical grid includes selecting, at least, a subset of a plurality of inverter-based resources at the power generating farm having grid forming capability and an anchor power generating asset that are capable of contributing to the blackstart based on one or more parameters. The plurality of inverter-based resources are connected to the electrical grid via a transmission network. The method includes utilizing the grid forming capability of the subset of the plurality of inverter-based resources for initial start-up to bring the subset of the plurality of inverter-based resources online and form a plurality of islands, thereby partially re-energizing the transmission network and enabling restoration of one or more critical loads within a first time period during the blackstart. During a subsequent, second time period, the method includes further energizing the transmission network to fully restore the electrical grid to normal operation.

### FIELD

The present disclosure relates generally to inverter-based resources and, more particularly, to systems and methods for providing blackstart of grid-forming inverter-based resources.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. For example, rotor blades typically have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is typically geared to a generator for producing electricity.

Wind turbines can be distinguished in two types: fixed speed and variable speed turbines. Conventionally, variable speed wind turbines are controlled as current sources connected to a power grid. In other words, the variable speed wind turbines rely on a grid frequency detected by a phase locked loop (PLL) as a reference and inject a specified amount of current into the grid. The conventional current source control of the wind turbines is based on the assumptions that the grid voltage waveforms are fundamental voltage waveforms with fixed frequency and magnitude and that the penetration of wind power into the grid is low enough so as to not cause disturbances to the grid voltage magnitude and frequency. Thus, the wind turbines simply inject the specified current into the grid based on the fundamental voltage waveforms. However, with the rapid growth of the wind power, wind power penetration into some grids has increased to the point where wind turbine generators have a significant impact on the grid voltage and frequency. When wind turbines are located in a weak grid, wind turbine power fluctuations may lead to an increase in magnitude and frequency variations in the grid voltage. These fluctuations may adversely affect the performance and stability of the PLL and wind turbine current control and adversely affect the performance of loads connected to the network.

Furthermore, many existing renewable generation converters, such as double-fed wind turbine generators, operate in a “grid-following” mode. Grid-following type devices utilize fast current-regulation loops to control active and reactive power exchanged with the grid. More specifically, FIG. 1 illustrates the basic elements of the main circuit and converter control structure for a grid-following double-fed wind turbine generator. As shown, the active power reference to the converter is developed by the energy source regulator, e.g., the turbine control portion of a wind turbine. This is conveyed as a torque reference which represents the lesser of the maximum attainable power from the energy source at that instant, or a curtailment command from a higher-level grid controller. The converter control then determines a current reference for the active component of current to achieve the desired torque. Accordingly, the double-fed wind turbine generator includes functions that manage the voltage and reactive power in a manner that results in a command for the reactive component of current. Wide-bandwidth current regulators then develop commands for voltage to be applied by the converters to the system, such that the actual currents closely track the commands.

Alternatively, grid-forming type converters provide a voltage-source characteristic, where the angle and magnitude of the voltage are controlled to achieve the regulation functions needed by the grid. With this structure, current will flow according to the demands of the grid while the converter contributes to establishing a voltage and frequency for the grid. This characteristic is comparable to conventional generators based on a turbine driving a synchronous machine. Thus, a grid-forming source must include the following basic functions: (1) support grid voltage and frequency for any current flow within the rating of the equipment, both real and reactive; (2) prevent operation beyond equipment voltage or current capability by allowing grid voltage or frequency to change rather than disconnecting equipment (disconnection is allowed only when voltage or frequency are outside of bounds established by the grid entity); (3) remain stable for any grid configuration or load characteristic, including serving an isolated load or connected with other grid-forming sources, and switching between such configurations; (4) share total load of the grid among other grid-forming sources connected to the grid; (5) ride through grid disturbances, both major and minor, and (6) meet requirements (1)-(5) without requiring fast communication with other control systems existing in the grid, or externally-created logic signals related to grid configuration changes.

The basic control structure to achieve the above grid-forming objectives was developed and field-proven for battery systems in the early 1990's (see e.g., U.S. Pat. No. 5,798,633 entitled “Battery Energy Storage Power Conditioning System”). Applications to full-converter wind generators and solar generators are disclosed in United States Publication No.: 2010/0142237 entitled “System and Method for Control of a Grid Connected Power Generating System,” and U.S. Pat. No. 9,270,194 entitled “Controller for controlling a power converter.” However, such implementations have been employed on full-converter wind generators.

Blackstart capability of a conventional generator is an important element in grid restoration following a blackout. With inverter-based resources displacing many synchronous generators in the grid, there is an emerging grid requirement for inverter-based resources to provide blackstart capability similar to conventional generators. Grid forming inverter-based resources can be capable of providing blackstart.

In view of the foregoing, the present disclosure is directed to systems and method that leverage the grid forming capability of multiple individual inverter-based resources to provide a coordinated blackstart of a larger capacity than individual inverter-based resources acting independently. This improved capacity from large wind clusters would be comparable to the large capacity offered by synchronous generators.

### BRIEF DESCRIPTION

Aspects and advantages of the invention will be set forth in part in the following description, or may be obvious from the description, or may be learned through practice of the invention.

In an aspect, the present disclosure is directed to a method of synchronized blackstart in a power generating farm connected to an electrical grid. The method includes selecting, at least, a subset of a plurality of inverter-based resources at the power generating farm having grid forming capability and an anchor power generating asset that are capable of contributing to the blackstart based on one or more parameters. The plurality of inverter-based resources are connected to the electrical grid via a transmission network. The method includes utilizing the grid forming capability of the subset of the plurality of inverter-based resources for initial start-up to bring the subset of the plurality of inverter-based resources online and form a plurality of islands, thereby partially re-energizing the transmission network and enabling restoration of one or more critical loads within a first time period during the blackstart. During a subsequent, second time period, the method includes further energizing the transmission network to fully restore the electrical grid to normal operation.

In another aspect, the present disclosure is directed to a wind farm connected to an electrical grid. The wind farm includes a plurality of wind turbines connected to the electrical grid via a transmission network and a controller having at least one processor. The processor(s) is configured to perform a plurality of operations, including but not limited to selecting, at least, a subset of the plurality of wind turbines having grid forming capability and an anchor power generating asset that are capable of contributing to blackstart based on one or more parameters, utilizing the grid forming capability of the subset of the plurality of wind turbines for initial start-up to bring the subset of the plurality of wind turbines online and form a plurality of islands, thereby partially re-energizing the transmission network and enabling restoration of one or more critical loads within a first time period during the blackstart, and during a subsequent, second time period, further energizing the transmission network to fully restore the electrical grid to normal operation.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a one-line diagram of a double-fed wind turbine generator with structure of converter controls for grid-following application according to conventional construction;

FIG. 2 illustrates a perspective view of one embodiment of a wind turbine according to the present disclosure;

FIG. 3 illustrates a simplified, internal view of one embodiment of a nacelle according to the present disclosure;

FIG. 4 illustrates a schematic view of one embodiment of a wind turbine electrical power system suitable for use with the wind turbine shown in FIG. 1;

FIG. 5 illustrates a schematic view of one embodiment of a wind farm having a plurality of wind turbines according to the present disclosure;

FIG. 6 illustrates a block diagram of one embodiment of a controller according to the present disclosure;

FIG. 7 illustrates a one-line diagram of a double-fed wind turbine generator with converter controls for grid-forming application according to the present disclosure;

FIG. 8 illustrates a flow diagram of an embodiment of a method of synchronized blackstart in a power generating farm connected to an electrical grid according to the present disclosure;

FIG. 9 illustrates a schematic network diagram of an embodiment of a system for providing synchronized blackstart in a power generating farm connected to an electrical grid according to the present disclosure;

FIG. 10 illustrates a schematic diagram of an embodiment of a system for providing synchronized blackstart in a wind farm connected to an electrical grid according to the present disclosure, particularly illustrating selection of a droop gain for rotor-side converters of the wind farm; and

FIGS. 11A and 11B illustrate schematic diagrams of an embodiment of a system for providing synchronized blackstart in a wind farm connected to an electrical grid according to the present disclosure, particularly illustrating grid forming control of rotor-side converters of a wind turbine using the selected droop gain.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Increasing levels of renewable integration is linked to increasing costs of grid security. As such, emerging grid codes require inverter-based resources to provide functionality that have been traditionally provided by synchronous generators. An example of such functionality is for the generation resource to provide blackstart capability. In view of the foregoing, the present disclosure is directed to systems and methods of providing blackstart for providing blackstart of grid-forming inverter-based resources. In an embodiment, for example, the method of the present disclosure can select a group of inverter-based resources having grid forming and grid following capability. Such inverter-based resources can thus contribute to blackstart of a grid based on, for example, wind conditions, wind farm layout, local loads, power reserve requirements, etc. The method of the present disclosure can then establish a sequence of operations, such as bringing selected turbines and loads online to form islands. This step may further involve control design and coordination to ensure stable operation. The method of the present disclosure may also participate in grid restoration by energization of the grid.

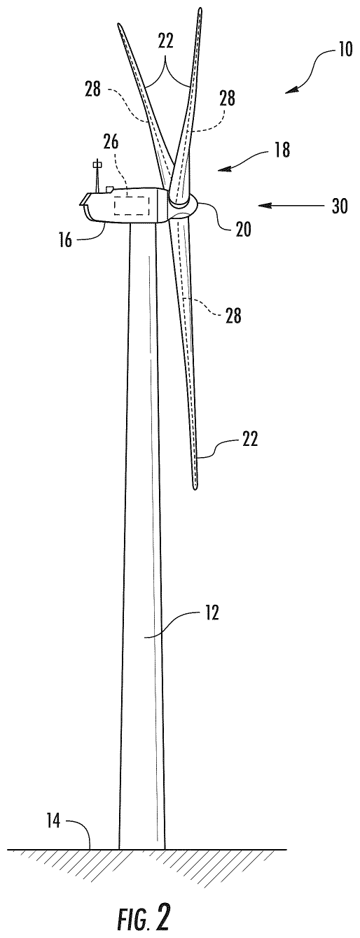

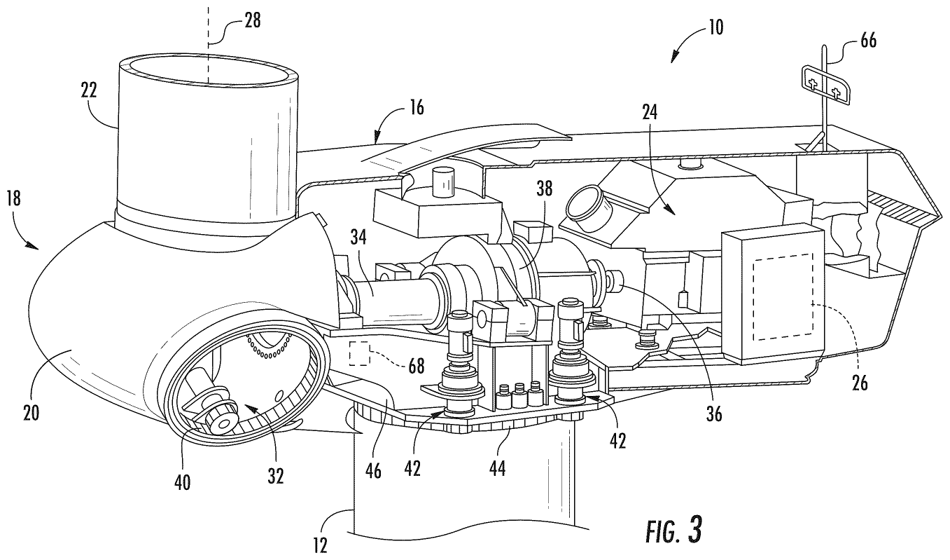

Referring now to the drawings, FIG. 2 illustrates a perspective view of one embodiment of a wind turbine 10 according to the present disclosure. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 3) positioned within the nacelle 16 to permit electrical energy to be produced.

The wind turbine 10 may also include a wind turbine controller 26 centralized within the nacelle 16. However, in other embodiments, the controller 26 may be located within any other component of the wind turbine 10 or at a location outside the wind turbine 10. Further, the controller 26 may be communicatively coupled to any number of the components of the wind turbine 10 in order to control the operation of such components and/or implement a corrective or control action. As such, the controller 26 may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals. Accordingly, the controller 26 may generally be configured to control the various operating modes (e.g., start-up or shut-down sequences), de-rating or up-rating the wind turbine, and/or individual components of the wind turbine 10.

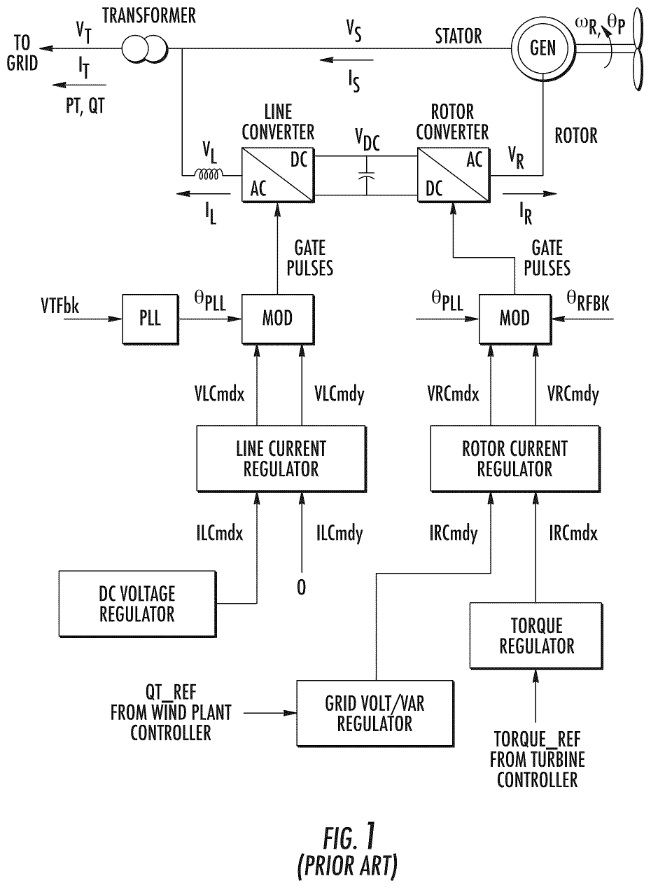

Referring now to FIG. 2, a simplified, internal view of one embodiment of the nacelle 16 of the wind turbine 10 shown in FIG. 1 is illustrated. As shown, a generator 24 may be disposed within the nacelle 16 and supported atop a bedplate 46. In general, the generator 24 may be coupled to the rotor 18 for producing electrical power from the rotational energy generated by the rotor 18. For example, as shown in the illustrated embodiment, the rotor 18 may include a rotor shaft 34 coupled to the hub 20 for rotation therewith. The rotor shaft 34 may, in turn, be rotatably coupled to a generator shaft 36 of the generator 24 through a gearbox 38. As is generally understood, the rotor shaft 34 may provide a low speed, high torque input to the gearbox 38 in response to rotation of the rotor blades 22 and the hub 20. The gearbox 38 may then be configured to convert the low speed, high torque input to a high speed, low torque output to drive the generator shaft 36 and, thus, the generator 24.

The wind turbine 10 may also one or more pitch drive mechanisms 32 communicatively coupled to the wind turbine controller 26, with each pitch adjustment mechanism(s) 32 being configured to rotate a pitch bearing 40 and thus the individual rotor blade(s) 22 about its respective pitch axis 28. In addition, as shown, the wind turbine 10 may include one or more yaw drive mechanisms 42 configured to change the angle of the nacelle 16 relative to the wind (e.g., by engaging a yaw bearing 44 of the wind turbine 10 that is arranged between the nacelle 16 and the tower 12 of the wind turbine 10).

In addition, the wind turbine 10 may also include one or more sensors 66, 68 for monitoring various wind conditions of the wind turbine 10. For example, the incoming wind direction 52, wind speed, or any other suitable wind condition near of the wind turbine 10 may be measured, such as through use of a suitable weather sensor 66. Suitable weather sensors may include, for example, light detection and ranging devices, sonic detection and ranging devices, anemometers, wind vanes, barometers, radio detection and ranging devices or any other sensing device which can provide wind directional information now known or later developed in the art. Still further sensors 68 may be utilized to measure additional operating parameters of the wind turbine 10, such as voltage, current, vibration, etc. as described herein.

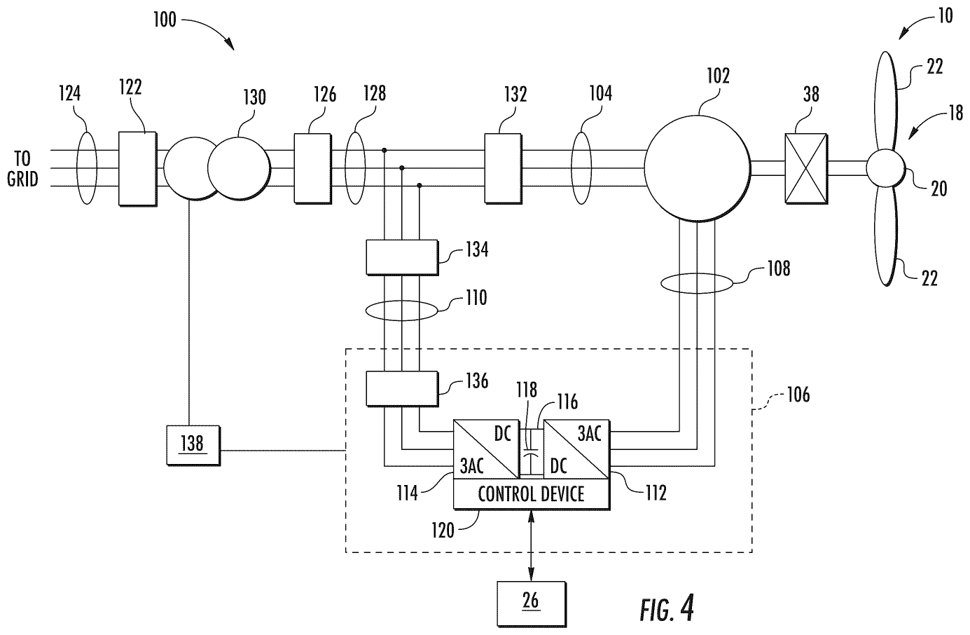

Referring now to FIG. 4, a schematic diagram of one embodiment of a wind turbine power system 100 is illustrated in accordance with aspects of the present disclosure. Although the present disclosure will generally be described herein with reference to the system 100 shown in FIG. 4, those of ordinary skill in the art, using the disclosures provided herein, should understand that aspects of the present disclosure may also be applicable in other power generation systems, and, as mentioned above, that the invention is not limited to wind turbine systems.

In the embodiment of FIG. 4 and as mentioned, the rotor 18 of the wind turbine 10 (FIG. 2) may, optionally, be coupled to the gearbox 38, which is, in turn, coupled to a generator 102, which may be a doubly fed induction generator (DFIG). As shown, the DFIG 102 may be connected to a stator bus 104. Further, as shown, a power converter 106 may be connected to the DFIG 102 via a rotor bus 108, and to the stator bus 104 via a line side bus 110. As such, the stator bus 104 may provide an output multiphase power (e.g., three-phase power) from a stator of the DFIG 102, and the rotor bus 108 may provide an output multiphase power (e.g., three-phase power) from a rotor of the DFIG 102. The power converter 106 may also include a rotor side converter (RSC) 112 and a line side converter (LSC) 114. The DFIG 102 is coupled via the rotor bus 108 to the rotor side converter 112. Additionally, the RSC 112 is coupled to the LSC 114 via a DC link 116 across which is a DC link capacitor 118. The LSC 114 is, in turn, coupled to the line side bus 110.

The RSC 112 and the LSC 114 may be configured for normal operating mode in a three-phase, pulse width modulation (PWM) arrangement using one or more switching devices, such as insulated gate bipolar transistor (IGBT) switching elements. In addition, the power converter 106 may be coupled to a converter controller 120 in order to control the operation of the rotor side converter 112 and/or the line side converter 114 as described herein. It should be noted that the converter controller 120 may be configured as an interface between the power converter 106 and the turbine controller 26 and may include any number of control devices.

In typical configurations, various line contactors and circuit breakers including, for example, a grid breaker 122 may also be included for isolating the various components as necessary for normal operation of the DFIG 102 during connection to and disconnection from a load, such as the electrical grid 124. For example, a system circuit breaker 126 may couple a system bus 128 to a transformer 130, which may be coupled to the electrical grid 124 via the grid breaker 122. In alternative embodiments, fuses may replace some or all of the circuit breakers.

In operation, alternating current power generated at the DFIG 102 by rotating the rotor 18 is provided to the electrical grid 124 via dual paths defined by the stator bus 104 and the rotor bus 108. On the rotor bus side 108, sinusoidal multi-phase (e.g., three-phase) alternating current (AC) power is provided to the power converter 106. The rotor side converter 112 converts the AC power provided from the rotor bus 108 into direct current (DC) power and provides the DC power to the DC link 116. As is generally understood, switching elements (e.g., IGBTs) used in the bridge circuits of the rotor side converter 112 may be modulated to convert the AC power provided from the rotor bus 108 into DC power suitable for the DC link 116.

In addition, the line side converter 114 converts the DC power on the DC link 116 into AC output power suitable for the electrical grid 124. In particular, switching elements (e.g., IGBTs) used in bridge circuits of the line side converter 114 can be modulated to convert the DC power on the DC link 116 into AC power on the line side bus 110. The AC power from the power converter 106 can be combined with the power from the stator of DFIG 102 to provide multi-phase power (e.g., three-phase power) having a frequency maintained substantially at the frequency of the electrical grid 124 (e.g., 50 Hz or 60 Hz).

Additionally, various circuit breakers and switches, such as grid breaker 122, system circuit breaker 126, stator sync switch 132, converter breaker 134, and line contactor 136 may be included in the wind turbine power system 100 to connect or disconnect corresponding buses, for example, when current flow is excessive and may damage components of the wind turbine power system 100 or for other operational considerations. Additional protection components may also be included in the wind turbine power system 100.

Moreover, the power converter 106 may receive control signals from, for instance, the local control system 176 via the converter controller 120. The control signals may be based, among other things, on sensed states or operating characteristics of the wind turbine power system 100. Typically, the control signals provide for control of the operation of the power converter 106. For example, feedback in the form of a sensed speed of the DFIG 102 may be used to control the conversion of the output power from the rotor bus 108 to maintain a proper and balanced multi-phase (e.g., three-phase) power supply. Other feedback from other sensors may also be used by the controller(s) 120, 26 to control the power converter 106, including, for example, stator and rotor bus voltages and current feedbacks. Using the various forms of feedback information, switching control signals (e.g., gate timing commands for IGBTs), stator synchronizing control signals, and circuit breaker signals may be generated.

The power converter 106 also compensates or adjusts the frequency of the three-phase power from the rotor for changes, for example, in the wind speed at the hub 20 and the rotor blades 22. Therefore, mechanical and electrical rotor frequencies are decoupled and the electrical stator and rotor frequency matching is facilitated substantially independently of the mechanical rotor speed.

Under some states, the bi-directional characteristics of the power converter 106, and specifically, the bi-directional characteristics of the LSC 114 and RSC 112, facilitate feeding back at least some of the generated electrical power into generator rotor. More specifically, electrical power may be transmitted from the stator bus 104 to the line side bus 110 and subsequently through the line contactor 136 and into the power converter 106, specifically the LSC 114 which acts as a rectifier and rectifies the sinusoidal, three-phase AC power to DC power. The DC power is transmitted into the DC link 116. The capacitor 118 facilitates mitigating DC link voltage amplitude variations by facilitating mitigation of a DC ripple sometimes associated with three-phase AC rectification.

The DC power is subsequently transmitted to the RSC 112 that converts the DC electrical power to a three-phase, sinusoidal AC electrical power by adjusting voltages, currents, and frequencies. This conversion is monitored and controlled via the converter controller 120. The converted AC power is transmitted from the RSC 112 via the rotor bus 108 to the generator rotor. In this manner, generator reactive power control is facilitated by controlling rotor current and voltage.

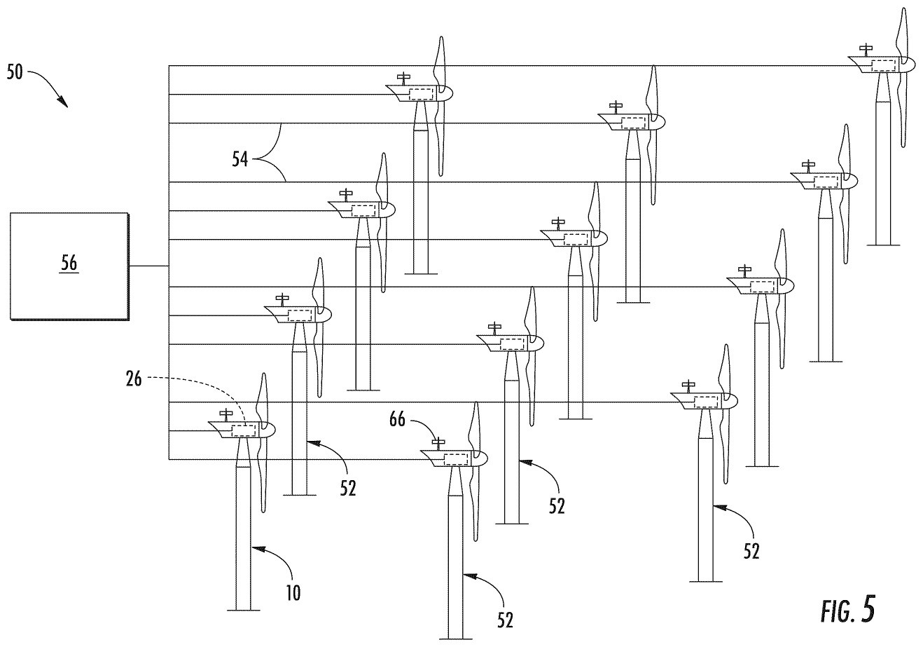

Referring now to FIG. 5, the wind turbine power system 100 described herein may be part of a wind farm 50. As shown, the wind farm 50 may include a plurality of wind turbines 52, including the wind turbine 10 described above, and an overall farm-level controller 56. For example, as shown in the illustrated embodiment, the wind farm 50 includes twelve wind turbines, including wind turbine 10. However, in other embodiments, the wind farm 50 may include any other number of wind turbines, such as less than twelve wind turbines or greater than twelve wind turbines. In one embodiment, the turbine controllers of the plurality of wind turbines 52 are communicatively coupled to the farm-level controller 56, e.g., through a wired connection, such as by connecting the turbine controller 26 through suitable communicative links 54 (e.g., a suitable cable). Alternatively, the turbine controllers may be communicatively coupled to the farm-level controller 56 through a wireless connection, such as by using any suitable wireless communications protocol known in the art. In further embodiments, the farm-level controller 56 is configured to send and receive control signals to and from the various wind turbines 52, such as for example, distributing real and/or reactive power demands across the wind turbines 52 of the wind farm 50.

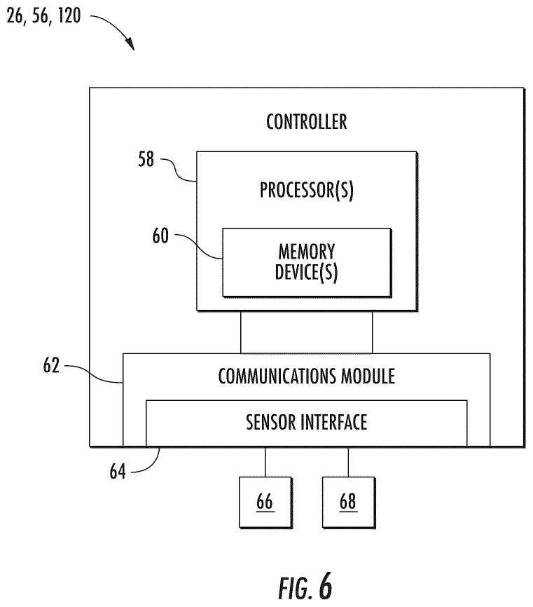

Referring now to FIG. 6, a block diagram of one embodiment of suitable components that may be included within the controller (such as any one of the converter controller 120, the turbine controller 26, and/or the farm-level controller 56 described herein) in accordance with example aspects of the present disclosure is illustrated. As shown, the controller may include one or more processor(s) 58, computer, or other suitable processing unit and associated memory device(s) 60 that may include suitable computer-readable instructions that, when implemented, configure the controller to perform various different functions, such as receiving, transmitting and/or executing wind turbine control signals (e.g., performing the methods, steps, calculations and the like disclosed herein).

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 60 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements.

Such memory device(s) 60 may generally be configured to store suitable computer-readable instructions that, when implemented by the processor(s) 58, configure the controller to perform various functions as described herein. Additionally, the controller may also include a communications interface 62 to facilitate communications between the controller and the various components of the wind turbine 10. An interface can include one or more circuits, terminals, pins, contacts, conductors, or other components for sending and receiving control signals. Moreover, the controller may include a sensor interface 64 (e.g., one or more analog-to-digital converters) to permit signals transmitted from the sensors 66, 68 to be converted into signals that can be understood and processed by the processor(s) 58.

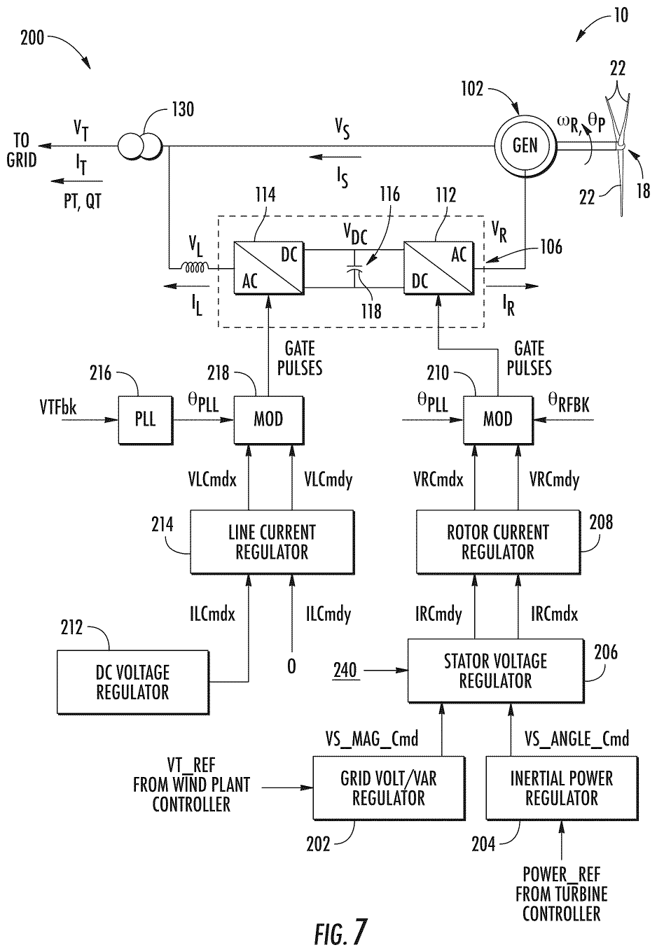

Referring now to FIG. 7, a schematic diagram of an embodiment of a grid forming power system 200 according to the present disclosure, particularly illustrating a one-line diagram of the double-fed wind turbine generator 102 with a high-level control structure for grid-forming characteristics. In particular, as shown, the grid forming power system 200 may include many of the same features of FIG. 4 described herein, with components having the same reference characters representing like components. Further, as shown, the grid forming power system 200 may include a control structure for controlling the line side converter that is similar to the control structure shown in FIG. 1. More particularly, as shown, the line side converter control structure may include a DC regulator 212 and a line current regulator 214. The DC regulator 212 is configured to generate line-side current commands for the line current regulator 214. The line current regulator 214 then generates line-side voltage commands for a modulator 218. The modulator 218 also receives an output (e.g., a phase-locked loop angle) from a phase-locked loop 216 to generate one or more gate pulses for the line side converter 114. The phase-locked loop 216 typically generates its output using a voltage feedback signal.

Furthermore, as shown, the grid forming power system 200 may also include a unique control structure for controlling the rotor side converter 112 using grid-forming characteristics. In particular, as shown in FIG. 7, the grid forming power system 200 may include a stator voltage regulator 206 for providing such grid-forming characteristics. In addition, as shown, the grid forming power system 200 may include a grid voltage/VAR regulator 202, an inertial power regulator 204, a rotor current regulator 208, and a modulator 210.

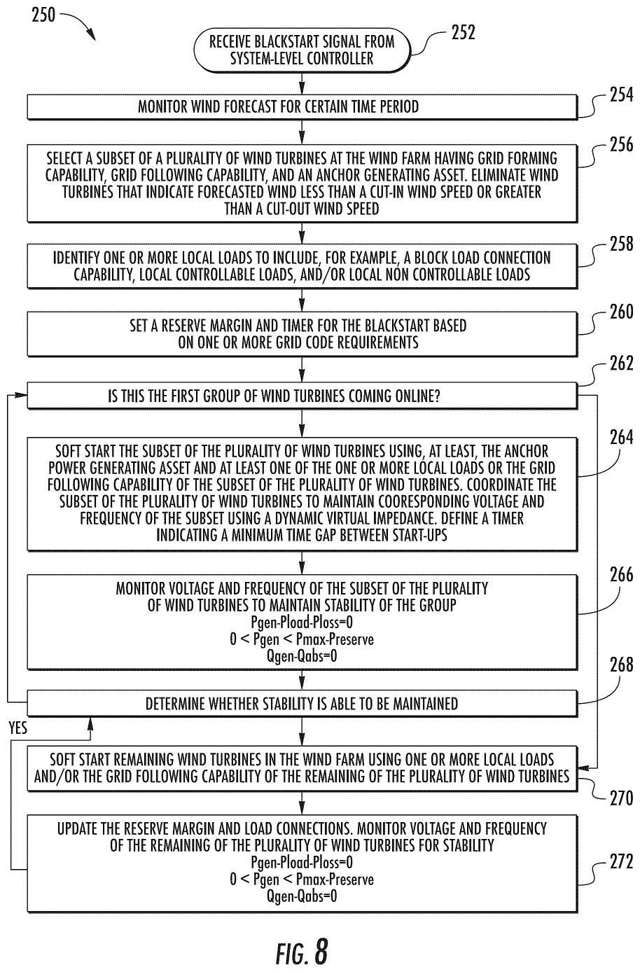

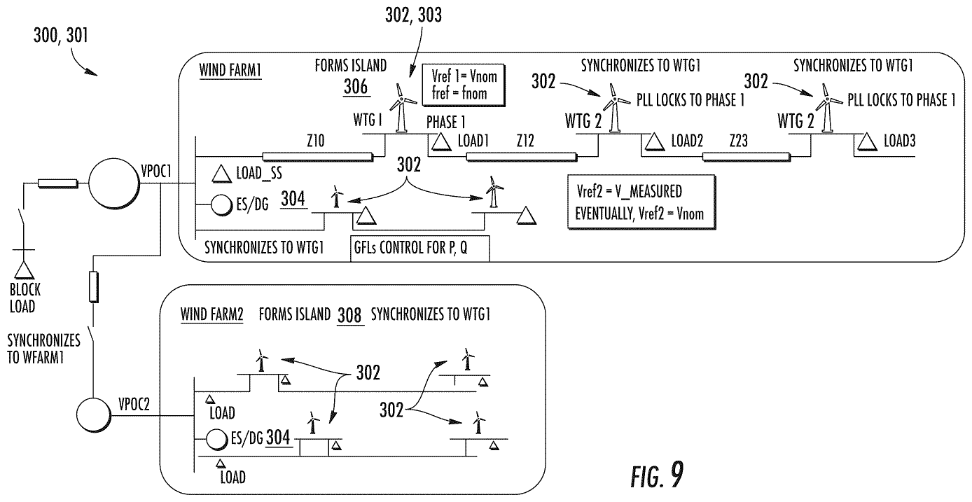

More particularly, as will be explained, the grid forming power system 200 includes an inner-loop current-regulator structure and a fast stator voltage regulator to convert voltage commands from the grid-forming controls to rotor current regulator commands. Thus, the system and method of the present disclosure provide control of the rotor voltage of the generator 102 to meet a higher-level command for magnitude and angle of stator voltage. Such control must be relatively fast and insensitive to current flowing in the stator of the double-fed wind turbine generator 102. Referring now to FIGS. 8 and 9, the present disclosure is directed to a method 250 and a system 300 of synchronized blackstart in a power generating farm connected to an electrical grid according to the present disclosure. In particular, FIG. 8 illustrates a flow diagram of an embodiment of a method 250 of synchronized blackstart in a power generating farm connected to an electrical grid according to the present disclosure, whereas FIG. 9 illustrates a schematic diagram of a system 300 of synchronized blackstart in a wind farm 301 connected to an electrical grid according to the present disclosure. In general, the method 250 is described herein with reference to the wind turbine 10 and the wind farm 50 of FIGS. 2-7. However, it should be appreciated that the disclosed method 250 may be implemented with any inverter-based resources in addition to wind turbines having any other suitable configurations. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (252), the method 250 may include receiving a blackstart signal from a controller, such as a system-level controller. Upon receipt of the blackstart signal, as shown at (254), the method 250 includes monitoring the wind forecast for a certain time period, such as for about four (4) hours to about six (6) hours (and up to 24 hours as needed based on grid code requirements).

As shown at (256), the method 250 includes selecting, at least, a subset of a plurality of wind turbines 302 at the wind farm 301 having grid forming capability, grid following capability, and an anchor power generating asset that are capable of contributing to the blackstart based on one or more parameters. For example, in an embodiment, the subset of the plurality of wind turbines 302 at the wind farm 301 may include a primary wind turbine 303 (e.g., WTG1) and any number of additional wind turbines 302 (e.g., WTG2 and WTG3). Moreover, as shown, the subset of the plurality of wind turbines 302 may be part of a first wind farm (e.g., Wind Farm 1) located at a first geographical location, whereas remaining wind turbines 302 may be located at a second geographical location (e.g., Wind Farm 2). Further, as shown in FIG. 9, the anchor power generating asset 304 may be an anchor generator (such as energy storage(ES) or diesel generator (DG)) at the wind farm(s). Further, in an embodiment, the plurality of wind turbines 302 are connected to the electrical grid via a transmission network. Thus, as shown, the wind turbines 302 in Wind Farm 1 and Wind Farm 2, as well as the anchor power generating asset(s) 304 are configured to synchronize to the primary wind turbine 303.

Moreover, in an embodiment, the parameter(s) used to determine whether an individual can contribute to blackstart may include one or more environmental conditions, a layout of the wind turbines 302, the one or more local loads (e.g., (e.g., Load_SS, Load 1, Load 2, Load 3, Load, etc. of FIG. 9), one or more power reserve requirements, or similar, and/or combinations thereof. Thus, in an embodiment, the selected subset of the plurality of wind turbines 302 may include wind turbines 302 having the largest capacity, wind range, electrical distance, presence of energy storage, state of charge, availability of the anchor power generating asset, etc. Further, as shown, in an embodiment, the method 250 may also include eliminating wind turbines 302 that indicate forecasted wind being less than a cut-in wind speed or greater than a cut out wind speed.

Still referring to FIG. 8, as shown at (258), the method 250 may include identifying one or more local loads for the subset of the plurality of wind turbines 302. For example, in an embodiment, the local load(s) may include a block load connection capability, controllable loads, and non-controllable loads of the wind farm. Further, as shown at (260), the method 250 includes setting a reserve margin and/or a timer for the blackstart based on one or more grid code requirements.

Thus, as shown at (262), the method 250 includes determining whether the subset of the plurality of wind turbines 302 is the first group of wind turbines coming online. If so, the method 250 includes utilizing the grid forming capability of the subset of the plurality of wind turbines 302 for initial start-up to bring the subset of the plurality of wind turbines 302 online and form a plurality of islands (e.g., 306, 308), thereby partially re-energizing the transmission network and enabling restoration of one or more critical loads within a first time period during the blackstart.

More specifically, as shown at (264) of FIG. 8, utilizing the grid forming capability of the subset of the plurality of wind turbines 302 for initial start-up may include soft starting the subset of the plurality of wind turbines 302 using, at least, the anchor power generating asset and at least one of the one or more local loads or the grid following capability of the subset of the plurality of wind turbines 302. For example, in an embodiment, soft starting the subset of the plurality of wind turbines 302 may include setting a voltage reference (e.g., V_{ref1} of FIG. 9) of the subset of the plurality of wind turbines 302 to a nominal voltage, setting a reference frequency (e.g., f of FIG. 9) of the subset of the plurality of wind turbines 302 to a nominal frequency (e.g., fₙₒₘ of FIG. 9), and utilizing grid following capability (GFL) for the subset of the plurality of wind turbines 302 to determine an active power reference (e.g., P) and a reactive power reference (e.g., Q) (e.g., GFLs control for P, Q in FIG. 9).

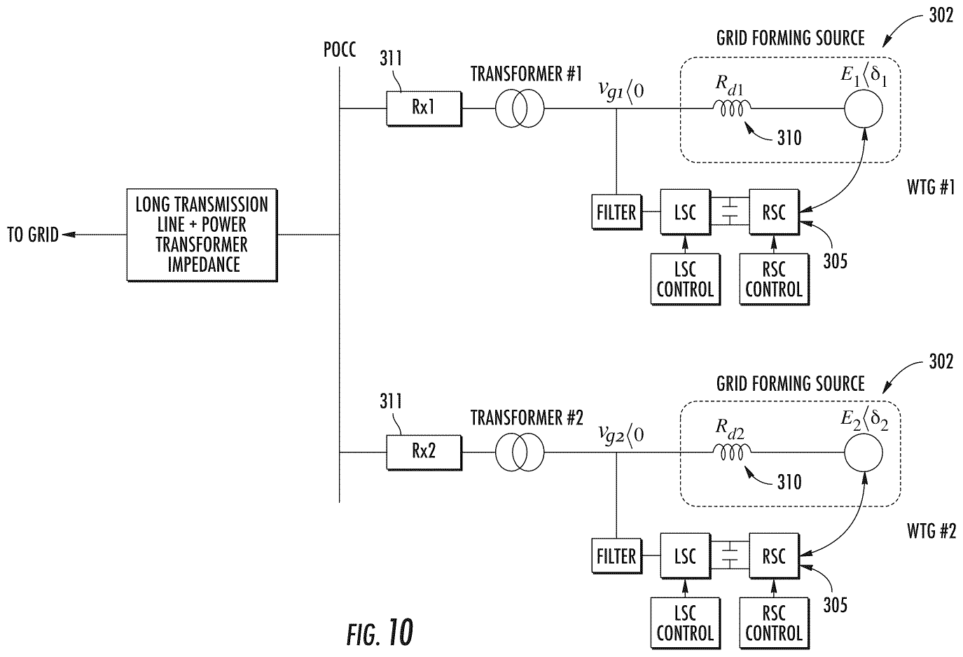

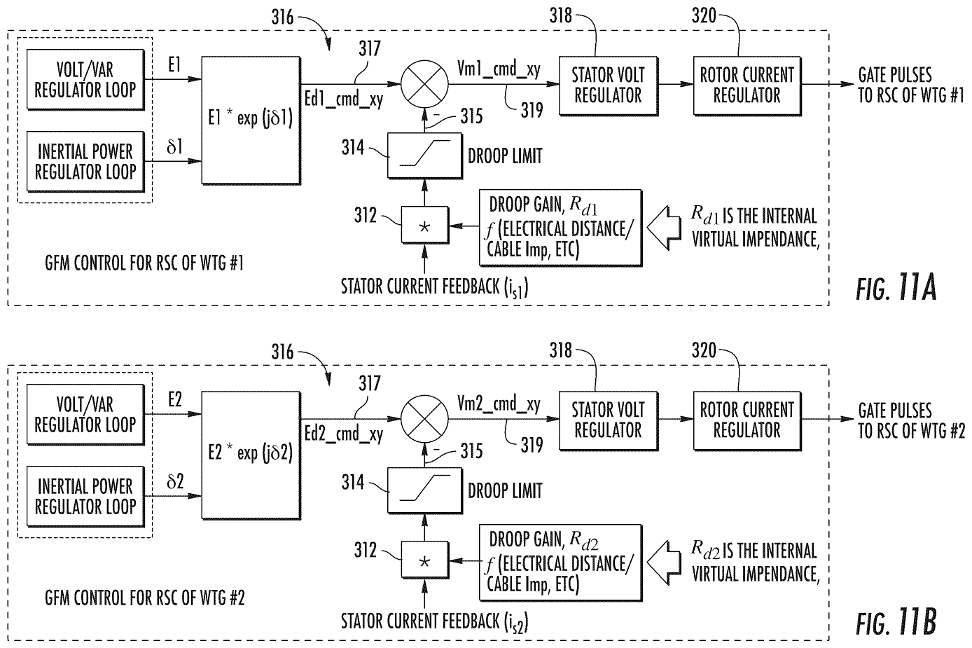

Referring back to FIG. 8, as shown at (264), utilizing the grid forming capability of the subset of the plurality of wind turbines 302 for initial start-up may further include coordinating the subset of the plurality of wind turbines 302 to maintain corresponding voltage and frequency of the subset of the plurality of wind turbines 302 using a virtual impedance (e.g., Rd1 and Rd2 in FIG. 10), for example, to tradeoff between inrush current reduction and voltage maintenance. For example, in an embodiment, coordinating the subset of the plurality of wind turbines 302 to maintain corresponding voltage and frequency of the subset of the plurality of wind turbines 302 using the dynamic virtual impedance may include using the dynamic virtual impedance in control of a power converter, such as a rotor side converter (see e.g., FIGS. 10, 11A, and 11B) of each wind turbine 302 or a line side converter to provide stable start-up of the subset of the plurality of wind turbines 302. Moreover, in an embodiment, the method 250 may include determining the dynamic virtual impedance as a function of a combination of at least two of the following: one or more gains, one or more factors relating to a state of the plurality of inverter-based resources, a cable impedance, a distance between neighboring inverter-based resources, transformer impedances in the energization path, and a nominal impedance, the state of the plurality of inverter-based resources comprising at least one of a start-up or steady-state.

Still referring to FIG. 8, in an embodiment, as shown at (264), utilizing the grid forming capability of the subset of the plurality of wind turbines 302 for initial start-up may include synchronizing or spacing apart timing of start-up of wind turbines 302 in the subset to improve coordination.

Furthermore, in an embodiment, as shown at (266), utilizing the grid forming capability of the subset of the plurality of wind turbines 302 for initial start-up may include monitoring the voltage and the frequency of the subset of the plurality of wind turbines 302 to maintain stability thereof. More specifically, as shown, the method 250 may include ensuring various relationships are satisfied to ensure stability of the blackstart. Example relationships are provided below as Relationships (1) through (3):

$${P}_{gen} - {P}_{load} - {P}_{loss} = 0 \qquad Relationship ( 1 )$$

$$0 < {P}_{gen} < {P}_{max} - {P}_{reserve} \qquad Relationship ( 2 )$$

$${Q}_{gen} - {Q}_{abs} = 0 \qquad Relationship ( 3 )$$

In particular, in an embodiment, the method 250 may include providing a real power balance between total power generated (e.g., P_{gen}) and total power consumed including losses (e.g., P_{load}+Pₗₒₛₛ). Moreover, in an embodiment, the method 250 may include providing maximum and minimum limits (e.g., Pₘₐₓ, Pᵣₑₛₑᵣᵥₑ) on the real power generation (e.g., P_{gen}) from generating wind turbines. In addition, in an embodiment, the method 250 may include providing a reactive power balance between generated reactive power (e.g., Q_{gen}) and absorbed reactive power (e.g., Q_{abs}).

As shown at (268), the method 250 further includes determining whether the stability is able to be maintained by the subset of the plurality of wind turbines. For example, in an embodiment, determining whether the stability is able to be maintained by the subset of the plurality of wind turbines may include comparing a measured voltage and a present voltage and determining whether the stability is able to be maintained by the subset of the plurality of inverter-based resources based on the comparison.

If the stability is unable to be maintained by the subset of the plurality of wind turbines, the method 250 includes selecting a different subset of the plurality of wind turbines at the wind farm with the grid forming capability for the soft starting. For example, in an embodiment, the method 250 may allow a certain number of attempts at maintaining stability (such as up to three (3) times) before moving to another, different subset of wind turbines.

If the stability is able to be maintained by the subset of the plurality of wind turbines, the method 250 continues at (270). In particular, during a subsequent, second time period, the method 250 includes further energizing the transmission network to fully restore the electrical grid to normal operation. More specifically, in an embodiment, as shown at (270), the method 250 further energizing the transmission network to fully restore the electrical grid to normal operation may include soft starting remaining of the plurality of wind turbines using at least one of the one or more local loads or the grid following capability of the remaining of the plurality of wind turbines. In such embodiments, for example, soft starting remaining of the plurality of wind turbines 302 may include initially setting a voltage reference (e.g., V_{ref2} of FIG. 9) of the remaining of the plurality of wind turbines 302 to a measured voltage (e.g., V_{_measured} of FIG. 9) and subsequently setting the voltage reference (e.g., V_{ref2} of FIG. 9) to the nominal voltage (e.g., Vₙₒₘ) and setting a reference frequency (e.g., f_{ref}) of the remaining of the plurality of wind turbines 302 to the nominal frequency (e.g., fₙₒₘ). Further, as shown, in an embodiment, soft starting remaining of the plurality of wind turbines 302 may further include utilizing the grid following capability for the remaining of the plurality of wind turbines 302 to determine an active power reference and a reactive power reference (e.g., P and Q).

Accordingly, as shown at (272) of FIG. 8, the method 250 includes updating the reserve margin and load connections. Moreover, the method 250 may include monitoring the voltage and the frequency of the remaining of the plurality of wind turbines to maintain stability thereof. More specifically, as shown and mentioned, the method 250 may include ensuring various relationships are satisfied to ensure stability of the blackstart using the remaining of the plurality of wind turbines (e.g., Relationships (1) through (3) provided herein).

Thus, the grid-forming wind turbines in the system 300 can contribute to blackstart similar to synchronous generators and coordination of the start-up of the wind turbines. More specifically, as mentioned, the plurality of wind turbines 302 may be located at different areas (e.g., as represented by Wind Farm 1 and Wind Farm 2), such that each wind turbine in the different areas can contribute to blackstart differently. For example, in an embodiment, up to 100 or more wind turbines may contribute to blackstart, with coordination between the wind turbines improving the energization capability. Further, in an embodiment, bigger and few wind turbines may be selected over smaller and more wind turbines. Moreover, in an embodiment, electrically far wind turbines may be selected rather than electrically closer wind turbines to improve stability. Thus, in such embodiments, the system 300 is configured to generate a virtual impedance (e.g., Z10, Z12, and Z23) based on, for example, electrical distance. In addition, in an embodiment, the system 300 may apply a time synchronization of control for energization of the grid.

Accordingly, the system 300 is configured to set a frequency reference for the selected subset of wind turbines 302. In such embodiments, this frequency reference can be determined based on one or more local loads (e.g., Load_SS, Load 1, Load 2, Load 3, Load, etc.), GPS, or TSO. Thus, in an embodiment, other grid-forming wind turbine groups (such as those in Wind Farm 2 in FIG. 9) connect at the reference frequency to the grid formed by the first group (such as those in Wind Farm 1 in FIG. 9).

Other grid-following groups of wind turbines can be connected to the grid after the first group/subset. Further, in an embodiment, inrush currents can be limited by soft starting the grid-forming wind turbines, i.e., starting with high virtual impedance and reducing gradually. Moreover, in an embodiment, the system 300 is configured to implement reactive power sharing.

Accordingly, the method 250 and the system 300 of the present disclosure are knowledgeable of information relating to neighboring wind turbines 302 such that coordination between start-up of each wind turbine is possible. Thus, the method 250 and the system 300 of the present disclosure provides improved response time to blackouts and an improved capability of providing blackstart over individual wind turbines operating independently. Furthermore, the method 250 and the system 300 of the present disclosure are configured to monitor the voltage phase and magnitude of each wind turbine. Thus, in an embodiment, the method 250 and the system 300 of the present disclosure may include reference control parameter communication data that includes a time stamp and actual parameter values. Accordingly, the wind turbine receiving the data is able to adjust the control. As such, in an embodiment, the method 250 and the system 300 of the present disclosure may operate when connected to a loaded and unloaded grid by planning the load accordingly during the start-up sequence (e.g., using the controllable loads). Further, in an embodiment, the method 250 and the system 300 of the present disclosure operate by controlling the phase of the voltage while energizing different wind turbines during blackstart to provide system-level restoration.

Referring now to FIG. 10, a schematic diagram of an embodiment of droop gain selection for rotor-side converters of a wind farm according to the present disclosure is illustrated. As used herein, a droop gain 310 (e.g., Rd1, Rd2 in FIGS. 10, 11A and 11B) corresponds to a virtual impedance that can be incorporated into the rotor-side converters (RSCs) 305 (e.g., RSC control) of the wind turbines 302 for better synchronization. In particular, as shown, the droop gain 310 (e.g., Rd1, Rd2 in FIGS. 10, 11A, and 11B) can be a function of distance between the wind turbines 302, equivalent line impedance, etc. An actual impedance 311 (e.g., due to physical cable/line impedances) for each of the wind turbines 302 is illustrated in FIG. 10 as Rx1 and Rx2. Wind turbines that are electrically near to each other can have coupling effects and ultimately may lead to instability in the system. Accordingly, with the selection of higher internal virtual impedance by means of control, the wind turbines 302 can be made virtually more distant (i.e., electrically) and the inrush current in transformers and cables can be limited, thus ensuring stable operation. Also, higher virtual impedances ensure a smooth synchronization between the wind turbines 302 by reducing the coupling between them.

Referring now to FIGS. 11A and 11B, schematic diagrams of an embodiment of grid forming control of a first rotor-side converter (e.g., RSC1) and a second rotor-side converter (e.g., RSC2) of first and second wind turbines using the selected droop gain according to the present disclosure is illustrated. In particular, the internal virtual impedances (e.g., Rd1, Rd2) can be selected using Relationships (4) and (5) below:

$${R}_{d 1} = k 1 + k / ( cable impedance of WT 1 ) \qquad Relationship ( 4 )$$

$${R}_{d 2} = k 1 + k / ( cable impedance of WT 2 ) \qquad Relationship ( 5 )$$

where k1 is the nominal virtual impedance and depends on grid short circuit ratio (SCR), and k is a factor that can set higher during start-up and settle to a lower value in steady state.

Thus, as shown, the virtual impedances (e.g., Rd1, Rd2) can be implemented into the RSC control by multiplying the virtual impedances by a stator current feedback, as shown at 312. Further, as shown at 314, a limit may be applied and an output 315 from the limiter 314 can be integrated into the control path 316 of the rotor-side converter(s). In particular, as shown, the output 315 may be subtracted from a control signal 317 in the control path 316 to determine a voltage signal 319 (e.g., Vm_cmd_xy). Thus, as shown, the voltage signal 319 can be used by a stator voltage regulator 318 and a rotor current regulator 320 to generate gate pulses for a respective rotor-side converter.

Further aspects of the invention are provided by the subject matter of the following clauses:

A method of synchronized blackstart in a power generating farm connected to an electrical grid, the method comprising: selecting, at least, a subset of a plurality of inverter-based resources at the power generating farm having grid forming capability and an anchor power generating asset that are capable of contributing to the blackstart based on one or more parameters, the plurality of inverter-based resources being connected to the electrical grid via a transmission network; utilizing the grid forming capability of the subset of the plurality of inverter-based resources for initial start-up to bring the subset of the plurality of inverter-based resources online and form a plurality of islands, thereby partially re-energizing the transmission network and enabling restoration of one or more critical loads within a first time period during the blackstart; and during a subsequent, second time period, further energizing the transmission network to fully restore the electrical grid to normal operation.

The method of any preceding clause, further comprising identifying one or more local loads for the subset of the plurality of inverter-based resources, the one or more local loads comprising at least one of a block load connection capability, controllable loads, and non-controllable loads of the power generating farm.

The method of any preceding clause, wherein the one or more parameters comprise at least one of one or more environmental conditions, a layout of the inverter-based resources, the one or more local loads, one or more power reserve requirements, or combinations thereof.

The method of any preceding clause, wherein utilizing the grid forming capability of the subset of the plurality of inverter-based resources for initial start-up further comprises: soft starting the subset of the plurality of inverter-based resources using, at least, the anchor power generating asset and at least one of the one or more local loads or a grid following capability of the subset of the plurality of inverter-based resources.

The method of any preceding clause, wherein soft starting the subset of the plurality of inverter-based resources using, at least, the anchor power generating asset and at least one of the one or more local loads or the grid following capability of the subset of the plurality of inverter-based resources further comprises: setting a voltage reference of the subset of the plurality of inverter-based resources to a nominal voltage; setting a reference frequency of the subset of the plurality of inverter-based resources to a nominal frequency; and utilizing the grid following capability for the subset of the plurality of inverter-based resources to determine an active power reference and a reactive power reference.

The method of any preceding clause, wherein utilizing the grid forming capability of the subset of the plurality of inverter-based resources for initial start-up further comprises: coordinating the subset of the plurality of inverter-based resources to maintain corresponding voltage and frequency of the subset of the plurality of inverter-based resources using a dynamic virtual impedance.

The method of any preceding clause, wherein utilizing the grid forming capability of the subset of the plurality of inverter-based resources for initial start-up further comprises: monitoring the voltage and the frequency of the subset of the plurality of inverter-based resources to maintain stability thereof.

The method of any preceding clause, wherein the plurality of inverter-based resources is a plurality of wind turbines, wherein coordinating the subset of the plurality of inverter-based resources to maintain corresponding voltage and frequency of the subset of the plurality of inverter-based resources using a dynamic virtual impedance further comprises: using the dynamic virtual impedance in control of a power converter of each wind turbine in the subset of the plurality of wind turbines to provide stable start-up of the subset of the plurality of wind turbines.

The method of any preceding clause, further comprising determining the dynamic virtual impedance as a function of a combination of at least two of the following: one or more gains, one or more factors relating to a state of the plurality of inverter-based resources, a cable impedance, a distance between neighboring inverter-based resources, transformer impedance in energization path, and a nominal impedance, the state of the plurality of inverter-based resources comprising at least one of a start-up or steady-state.

The method of any preceding clause, wherein utilizing the grid forming capability of the subset of the plurality of inverter-based resources for initial start-up further comprises: synchronizing or spacing apart timing of start-up of the subset of the plurality of inverter-based resources to improve coordination.

The method of any preceding clause, further comprising: determining whether the stability is able to be maintained by the subset of the plurality of inverter-based resources; if the stability is unable to be maintained by the subset of the plurality of inverter-based resources, selecting a different subset of the plurality of inverter-based resources at the power generating farm with the grid forming capability for the soft starting; and if the stability is able to be maintained by the subset of the plurality of inverter-based resources, soft starting remaining of the plurality of inverter-based resources using at least one of the one or more local loads or the grid following capability of the subset of the remaining of the plurality of inverter-based resources.

The method of any preceding clause, wherein determining whether the stability is able to be maintained by the subset of the plurality of inverter-based resources further comprises comparing a measured voltage and a present voltage and determining whether the stability is able to be maintained by the subset of the plurality of inverter-based resources based on the comparison.

The method of any preceding clause, wherein soft starting remaining of the plurality of inverter-based resources using at least one of the one or more local loads or the grid following capability of the subset of the plurality of inverter-based resources further comprises: initially setting a voltage reference of the remaining of the plurality of inverter-based resources to a measured voltage and subsequently setting the voltage reference to the nominal voltage; setting a reference frequency of the remaining of the plurality of inverter-based resources to the nominal frequency; and utilizing grid following capability for the remaining of the plurality of inverter-based resources to determine an active power reference and a reactive power reference.

The method of any preceding clause, wherein the anchor power generating asset is an anchor generator at the power generating farm.

A wind farm connected to an electrical grid, the wind farm comprising: a plurality of wind turbines connected to the electrical grid via a transmission network; a controller comprising at least one processor, the at least one processor configured to perform a plurality of operations, the plurality of operations comprising: selecting, at least, a subset of the plurality of wind turbines having grid forming capability and an anchor power generating asset that are capable of contributing to blackstart based on one or more parameters; utilizing the grid forming capability of the subset of the plurality of wind turbines for initial start-up to bring the subset of the plurality of wind turbines online and form a plurality of islands, thereby partially re-energizing the transmission network and enabling restoration of one or more critical loads within a first time period during the blackstart; and during a subsequent, second time period, further energizing the transmission network to fully restore the electrical grid to normal operation.

The wind farm of any preceding clause, wherein the one or more parameters comprise at least one of one or more environmental conditions, a layout of the inverter-based resources, one or more local loads, one or more power reserve requirements, or combinations thereof.

The wind farm of any preceding clause, wherein utilizing the grid forming capability of the subset of the plurality of wind turbines for initial start-up further comprises: soft starting the subset of the plurality of wind turbines using, at least, the anchor power generating asset and at least one of local loads or a grid following capability of the subset of the plurality of inverter-based resources.

The wind farm of any preceding clause, wherein soft starting the subset of the plurality of wind turbines using, at least, the anchor power generating asset and at least one of the local loads or the grid following capability of the subset of the plurality of wind turbines further comprises: setting a voltage reference to a nominal voltage and a reference frequency to a nominal frequency for the subset of the plurality of inverter-based resources; setting the reference frequency to the nominal frequency for the subset of the plurality of inverter-based resources; and utilizing the grid following capability for the subset of the plurality of wind turbines to determine an active power reference and a reactive power reference.

The wind farm of any preceding clause, wherein utilizing the grid forming capability of the subset of the plurality of wind turbines for initial start-up further comprises: coordinating the subset of the plurality of wind turbines to maintain corresponding voltage and frequency of the subset of the plurality of wind turbines using a dynamic virtual impedance, wherein coordinating the subset of the plurality of wind turbines to maintain corresponding voltage and frequency of the subset of the plurality of wind turbines using a dynamic virtual impedance further comprises using the dynamic virtual impedance in control of a power converter of each wind turbine in the subset of the plurality of wind turbines to provide stable start-up of the subset of the plurality of wind turbines.

The wind farm of any preceding clause, wherein utilizing the grid forming capability of the subset of the plurality of wind turbines for initial start-up further comprises: synchronizing or spacing apart timing of start-up of the subset of the plurality of wind turbines to improve coordination.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of synchronized blackstart in a power generating farm connected to an electrical grid, the method comprising:
selecting, at least, a subset of a plurality of inverter-based resources at the power generating farm having grid forming capability and an anchor power generating asset that are capable of contributing to the blackstart based on one or more parameters, the plurality of inverter-based resources being connected to the electrical grid via a transmission network;
utilizing the grid forming capability of the subset of the plurality of inverter-based resources for initial start-up to bring the subset of the plurality of inverter-based resources online and form a plurality of islands, thereby partially re-energizing the transmission network and enabling restoration of one or more critical loads within a first time period during the blackstart; and
during a subsequent, second time period, further energizing the transmission network to fully restore the electrical grid to normal operation.

2. The method of claim 1, further comprising identifying one or more local loads for the subset of the plurality of inverter-based resources, the one or more local loads comprising at least one of a block load connection capability, controllable loads, and non-controllable loads of the power generating farm.

3. The method of claim 2, wherein the one or more parameters comprise at least one of one or more environmental conditions, a layout of the inverter-based resources, the one or more local loads, one or more power reserve requirements, or combinations thereof.

4. The method of claim 2, wherein utilizing the grid forming capability of the subset of the plurality of inverter-based resources for initial start-up further comprises:
soft starting the subset of the plurality of inverter-based resources using, at least, the anchor power generating asset and at least one of the one or more local loads or a grid following capability of the subset of the plurality of inverter-based resources.

5. The method of claim 4, wherein soft starting the subset of the plurality of inverter-based resources using, at least, the anchor power generating asset and at least one of the one or more local loads or the grid following capability of the subset of the plurality of inverter-based resources further comprises:
setting a voltage reference of the subset of the plurality of inverter-based resources to a nominal voltage;
setting a reference frequency of the subset of the plurality of inverter-based resources to a nominal frequency; and
utilizing the grid following capability for the subset of the plurality of inverter-based resources to determine an active power reference and a reactive power reference.

6. The method of claim 5, wherein utilizing the grid forming capability of the subset of the plurality of inverter-based resources for initial start-up further comprises:
coordinating the subset of the plurality of inverter-based resources to maintain corresponding voltage and frequency of the subset of the plurality of inverter-based resources using a dynamic virtual impedance.

7. The method of claim 6, wherein utilizing the grid forming capability of the subset of the plurality of inverter-based resources for initial start-up further comprises:
monitoring the voltage and the frequency of the subset of the plurality of inverter-based resources to maintain stability thereof.

8. The method of claim 6, wherein the plurality of inverter-based resources is a plurality of wind turbines, wherein coordinating the subset of the plurality of inverter-based resources to maintain corresponding voltage and frequency of the subset of the plurality of inverter-based resources using a dynamic virtual impedance further comprises:
using the dynamic virtual impedance in control of a power converter of each wind turbine in the subset of the plurality of wind turbines to provide stable start-up of the subset of the plurality of wind turbines.

9. The method of claim 6, further comprising determining the dynamic virtual impedance as a function of a combination of at least two of the following: one or more gains, one or more factors relating to a state of the plurality of inverter-based resources, a cable impedance, a distance between neighboring inverter-based resources, transformer impedance in energization path, and a nominal impedance, the state of the plurality of inverter-based resources comprising at least one of a start-up or steady-state.

10. The method of claim 9, wherein utilizing the grid forming capability of the subset of the plurality of inverter-based resources for initial start-up further comprises:
synchronizing or spacing apart timing of start-up of the subset of the plurality of inverter-based resources to improve coordination.

11. The method of claim 7, further comprising:
determining whether the stability is able to be maintained by the subset of the plurality of inverter-based resources;
if the stability is unable to be maintained by the subset of the plurality of inverter-based resources, selecting a different subset of the plurality of inverter-based resources at the power generating farm with the grid forming capability for the soft starting; and
if the stability is able to be maintained by the subset of the plurality of inverter-based resources, soft starting remaining of the plurality of inverter-based resources using at least one of the one or more local loads or the grid following capability of the subset of the remaining of the plurality of inverter-based resources.

12. The method of claim 11, wherein determining whether the stability is able to be maintained by the subset of the plurality of inverter-based resources further comprises comparing a measured voltage and a present voltage and determining whether the stability is able to be maintained by the subset of the plurality of inverter-based resources based on the comparison.

13. The method of claim 11, wherein soft starting remaining of the plurality of inverter-based resources using at least one of the one or more local loads or the grid following capability of the subset of the plurality of inverter-based resources further comprises:
initially setting a voltage reference of the remaining of the plurality of inverter-based resources to a measured voltage and subsequently setting the voltage reference to the nominal voltage;
setting a reference frequency of the remaining of the plurality of inverter-based resources to the nominal frequency; and
utilizing grid following capability for the remaining of the plurality of inverter-based resources to determine an active power reference and a reactive power reference.

14. The method of claim 1, wherein the anchor power generating asset is an anchor generator at the power generating farm.

15. A wind farm connected to an electrical grid, the wind farm comprising:
a plurality of wind turbines connected to the electrical grid via a transmission network;
a controller comprising at least one processor, the at least one processor configured to perform a plurality of operations, the plurality of operations comprising:
selecting, at least, a subset of the plurality of wind turbines having grid forming capability and an anchor power generating asset that are capable of contributing to blackstart based on one or more parameters;
utilizing the grid forming capability of the subset of the plurality of wind turbines for initial start-up to bring the subset of the plurality of wind turbines online and form a plurality of islands, thereby partially re-energizing the transmission network and enabling restoration of one or more critical loads within a first time period during the blackstart; and
during a subsequent, second time period, further energizing the transmission network to fully restore the electrical grid to normal operation.

16. The wind farm of claim 15, wherein the one or more parameters comprise at least one of one or more environmental conditions, a layout of the inverter-based resources, one or more local loads, one or more power reserve requirements, or combinations thereof.

17. The wind farm of claim 15, wherein utilizing the grid forming capability of the subset of the plurality of wind turbines for initial start-up further comprises:
soft starting the subset of the plurality of wind turbines using, at least, the anchor power generating asset and at least one of local loads or a grid following capability of the subset of the plurality of inverter-based resources.

18. The wind farm of claim 17, wherein soft starting the subset of the plurality of wind turbines using, at least, the anchor power generating asset and at least one of the local loads or the grid following capability of the subset of the plurality of wind turbines further comprises:
setting a voltage reference to a nominal voltage and a reference frequency to a nominal frequency for the subset of the plurality of inverter-based resources;
setting the reference frequency to the nominal frequency for the subset of the plurality of inverter-based resources; and
utilizing the grid following capability for the subset of the plurality of wind turbines to determine an active power reference and a reactive power reference.

19. The wind farm of claim 18, wherein utilizing the grid forming capability of the subset of the plurality of wind turbines for initial start-up further comprises:
coordinating the subset of the plurality of wind turbines to maintain corresponding voltage and frequency of the subset of the plurality of wind turbines using a dynamic virtual impedance, wherein coordinating the subset of the plurality of wind turbines to maintain corresponding voltage and frequency of the subset of the plurality of wind turbines using a dynamic virtual impedance further comprises using the dynamic virtual impedance in control of a power converter of each wind turbine in the subset of the plurality of wind turbines to provide stable start-up of the subset of the plurality of wind turbines.

20. The wind farm of claim 19, wherein utilizing the grid forming capability of the subset of the plurality of wind turbines for initial start-up further comprises:
synchronizing or spacing apart timing of start-up of the subset of the plurality of wind turbines to improve coordination.
